(19) United States
(12) Patent Application Publication
(10) Pub. No.: US 2007/0172043 A1
(43) Pub. Date: Jul. 26, 2007

(54) Ultimedia conference system

(75) Inventor: Joaquin Keller, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 10/581,600

(22) PCT Filed: Dec. 2, 2004
(86) PCT No.: PCT/FR04/50640

§ 371 Date: Mar. 6, 2007

(30) Foreign Application Priority Data
Dec. 5, 2003 (FR) 0350991

(51) Int. Cl. H04M 3/42

(52) U.S. Cl. 379/202.01

(57) ABSTRACT

A method for managing remote conferences including: receiving, via a device for managing conferences, data from a telephone conference bridge concerning the presence of participants in a conference, and determining the apparatuses of users to be included in a conference, by audio presence data and stored data identifying a user apparatus, in connection with the telephone number data.

### TECHNICAL FIELD AND PRIOR ART

The invention relates to the field of remote conference systems.

Such a system is known from document WO 03 034 235.

In this document, it is necessary to have a specific terminal.

Other existing methods (conventional methods) propose solutions for establishing more complex conferences during use and/or more costly for the user and more complex invoicing solutions during use and/or more costly both for the user and the operator of the system.

The problem is posed of finding other systems, which may simply establish a remote conference, or a conference at a distance, notably of the multimedia type.

### DISCUSSION OF THE INVENTION

The invention first relates to a device for managing remote conferences, including:
means for receiving from a telephone conference bridge, participant presence data in an audio conference, said audio presence data,
storage means for storing, for example as a database, user telephone number data and data identifying a user apparatus, in connection with the telephone number data,
means for determining, by means of the audio presence data and of stored data, the apparatuses of participants in a conference.

This device may further include means for sending conference data to devices of participants in a conference and/or means for identifying a request for sending conference data to an apparatus of a participant in a conference.

The invention also relates to a system for managing remote conferences, including an audio conference telephone bridge, a conference server, the telephone bridge providing the server with data relative to the presence of a user in an audio conference, the server associating each user present in the audio conference with a remote conference.

Means may be provided for determining the type of data from the conference data, which may be provided to an apparatus of a participant in a conference.

Also, means may be provided for sending to each apparatus of a user identified as a participant in a conference, data relative to the apparatuses of other users also participating in the conference. The different apparatuses may then exchange data with each other without prompting the management device or the server.

The invention also relates to a method for managing remote conferences, including:
receiving via a device for managing conferences, data from a telephone conference bridge, and concerning the presence of participants in a conference, so-called audio presence data,
determining the apparatuses of users participating or to be included in a conference, by means of audio presence data and of stored data identifying a user apparatus, in connection with the telephone number data.

Therefore, it is on the basis of the participation in an audio conference that a conference may be established via a management device or a server according to the invention.

The user may then either receive data other than audio data, for example multimedia data, via the management device, with or without any specific request, or the latter may provide this user or his/her terminal apparatus with the identification of the apparatuses or terminals of the users present in the conference, these different users then directly exchanging data without passing via the server.

With the invention, participants in a telephone conference may therefore have a multimedia conference available with the same participants as in the telephone conference.

### SHORT DESCRIPTION OF THE FIGURES

FIG. 1 illustrates a conference system according to the invention,

FIG. 2 illustrates steps of a method for establishing conferences according to the invention,

FIGS. 3 to 5 illustrate an embodiment of a system and of a method according to the invention.

### DETAILED DISCUSSION OF EMBODIMENTS OF THE INVENTION

A <<multimedia conference >> refers to a conference which allows its participants to exchange and to share a data type (video, sound, written documents, images, etc. . . . ). These data may be exchanged and/or shared synchronously or asynchronously. As exchanges or synchronous sharing, projection of transparencies or videos whereby the participants who express their wish to do so, watch and/or listen to the same thing or to videos in real time simultaneously as in a conventional multipoint videoconference, or even joint editing of documents may be mentioned.

A multimedia conference according to the invention relies on a data exchange network, for example the Internet network.

With computers, connected to this network, it is possible to acquire and/or send and/or forward and/or receive and/or restore, notably display, conference data, other than the audio data exchanged through the telephone network.

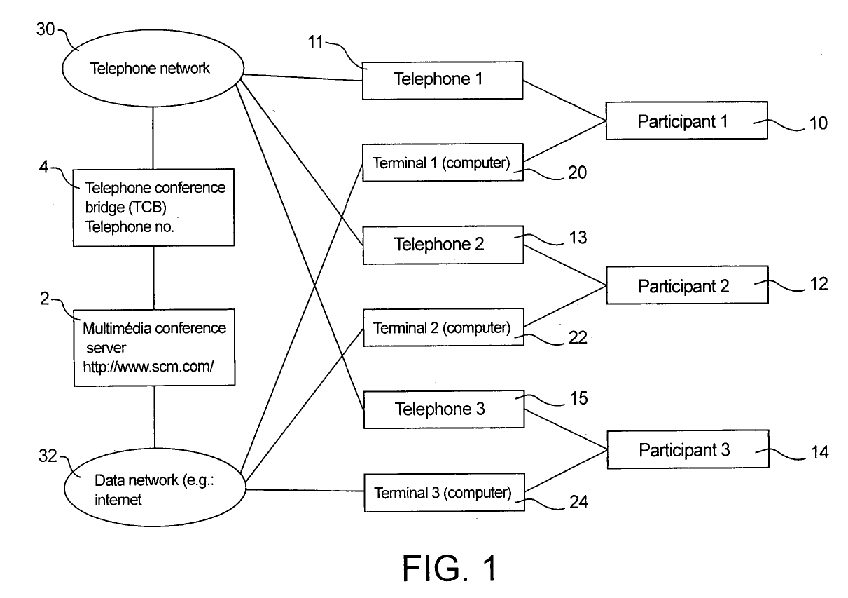

A first embodiment of the invention is illustrated in FIG. 1.

A computer 2, or multimedia conference server, is connected to a telephone conference bridge 4, references 30 and 32 designating a telephone network and a data network such as the Internet network, respectively.

When a user calls the bridge 4, in particular if there are more than one conference on the bridge, he/she optionally enters an identifier of the telephone conference.

If the telephone lines of the participants have a function for displaying the calling number, the telephone conference bridge 4 may directly be informed as to the telephone number of the calling user participating in the telephone conference.

The server 2 then obtains via a management or supervision interface of the bridge 4, the telephone numbers of the participants 10, 12, 14, in the telephone conference.

With the interfaces for managing the audio bridge, it is possible to recover the following data:

a) The list of the current conferences identified by an identifier (<<CONFS >>=ID).

b) The list of the participants in each conference, identified by their telephone number.

With the telephone number of a caller, it is therefore possible to retrieve his/her co-participants, his/her audio conference.

These interfaces may be polled and remote-controlled.

The computers 20, 22, 24 of the users are either associated in the server 2 with these telephone numbers: or data for identifying each apparatus 20-24, in association with the corresponding telephone number, are stored beforehand in the server, for example as a database, or each user apparatus provides the server 2 with these data upon requesting establishment of a conference or upon requesting access to an already established conference.

Association of the computer with the telephone set may be accomplished by providing the computer of the user with the telephone number associated with the telephone set.

This provision is accomplished either by manual entry by the user, or by another method if the telephone set and computer are connected to each other and if the telephone <<is aware >> of its own number.

For example a mobile telephone of a user may have a radio or infrared link with the computer of this user.

From the moment that the server 2 has identified, by means of the information provided by the bridge 4, that a user is connected in audio mode, this user and his/her apparatus may receive other data (multimedia data) relating to a conference.

The multimedia conference server 2 may then send these data directly to the terminal 20 which requests them.

The server 2 may thereby communicate the network identifiers of the participant terminals to one or more, optionally to each of the terminals of the other participants, who may thereby establish point-to-point communications with each other.

According to the invention, users may therefore establish a multimedia conference in association with a telephone conference.

The user establishes a telephone conference by calling a particular number (the one of the telephone conference bridge 4).

The operating mode therefore at first is the operating mode of a telephone conference bridge, a conference, for example a multimedia conference, being then accessible on the computer of the user associated with the telephone set of this same user.

Two operating modes of this system are therefore possible, optionally simultaneously.

According to a first operating mode, the computers or the terminals 20-24 of the participants, exclusively on a request presented to the server, obtain conference data which are exchanged and/or shared. These data are therefore requested by the apparatuses or terminals 20, 22, 24 of the participants to the multimedia conference server 2, at regular intervals or upon prompting the user participating in the conference.

The request assumes the form of a specific request addressed to the server. During this request, the requesting terminal provides the server 2 with an identifier which allows the latter to identify it and to determine the multimedia conference to which it belongs and the data to which it is entitled or to which it needs to have access.

For obtaining this identifier, the terminal 20 has carried out an identifier request to the server 2, for example a first request with which it sent the telephone number which is associated with it, as well as optional cryptographic information, for example a password.

The identifier may be the IP address of the terminal or the corresponding telephone number, or another identifier when none of these two identifiers is possible.

According a second operating mode, the terminals 20-24 are waiting for receiving conference data, for example multimedia type data.

A terminal carries out a identifier request as in the previous mode, but it sends, in addition to the telephone number, its network identifier, for example its IP address. This may be another identifier if it is not on an IP network.

According to this second mode, as soon as conference data are available in the server 2, they are transmitted to each apparatus of a participant in the conference, without any specific request from the latter, by means of the information on the network identifier.

An apparatus participating in a conference may be used by several persons participating in the conference. For example, a meeting room equipped for video-conferencing may be fitted with a single apparatus used by several persons who intervene in the conference.

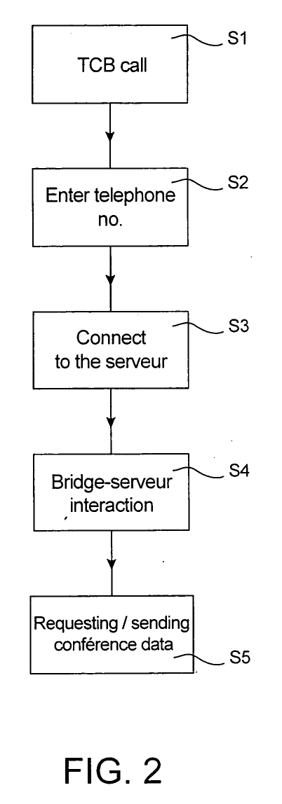

An exemplary method according to the invention or an exemplary use of a system according to the invention will now be described in connection with FIG. 2.

In a first step (S1), each of the participants 10-14, by means of his/her telephone 11, 13, 15 enters into communication with the bridge 4; a conventional telephone conference is thereby established.

The telephone number of each user is known or stored by his/her own terminal. Before or after this step S1, each participant may enter his/her telephone number in his/her own terminal (step S2, illustrated in FIG. 2 after S1).

Each participant then connects his/her terminal (step S3) to the server 2, by means of a web browser for example. Each terminal 20-24 may thus send information on itself and/or on the corresponding participant to the server 2.

The server 2 then proceeds with associating the telephone numbers and the terminals.

These phases S1-S3 may be performed in any order.

Next (step S4), the server 2 and the bridge 4 converse so as to allow the server 2 to be informed on the participants in the telephone conference.

This phase is repeated as often as necessary so that the data of the server 2 are updated, as the participants enter or leave the telephone conference.

The server 2 may therefore permanently be informed on the terminals 20-24 which participate in this conference.

In particular, as soon as a telephone communication is interrupted, the corresponding user is identified as having left the audio conference, the corresponding information is transmitted to the server 2, and the sending or the making of conference data available to this user and by the server is interrupted.

In the case of a point-to-point conference with several apparatuses, one of which is identified at a certain instant as having left, the other apparatuses are informed on the leaving of this apparatus or this terminal and any data exchange with the latter is interrupted.

During a step S5, the terminals send the multimedia data which they wish to exchange or share. This exchange may be carried out according to one of the modes described above.

According to the first mode, the terminals may poll the server 2 in order to obtain multimedia data corresponding to their multimedia conference.

The server 2 then sends to the terminals, upon their request, multimedia data of their conference by means of network identifiers of the terminals, identifiers which are known to the server as explained above.

In the second mode, the server 2 either sends data to each of the participants, without any specific request from the latter, or each terminal by conversing with the server 2, may have information on the terminals of other participants, including their respective network identifier. The terminals then directly send (point-to-point link) to other terminals, multimedia data, for example video streams from a camera installed on the terminal.

The latter steps may occur simultaneously and/or in any order.

In certain cases, a terminal is not directly connected to the data network supporting the multimedia conference.

For example, this is the case of terminals connected to a home or corporate private network and connecting to the data network supporting the conference (e.g.: public Internet) via a gateway, for example a NAT or proxy-http.

In that case, the terminal does not have any network identifier.

It may poll the server and the connected terminals directly but may not always receive data which have not been directly asked for. In this particular case, the terminal may not participate in the conference according to the second mode discussed above, i.e., by waiting for data relating to the conference. On the other hand, it may participate in a conference according to the first mode, i.e., by sending requests for data transmission to the server.

Invoicing of the multimedia conference may be carried out by using the invoicing system of the telephone conference.

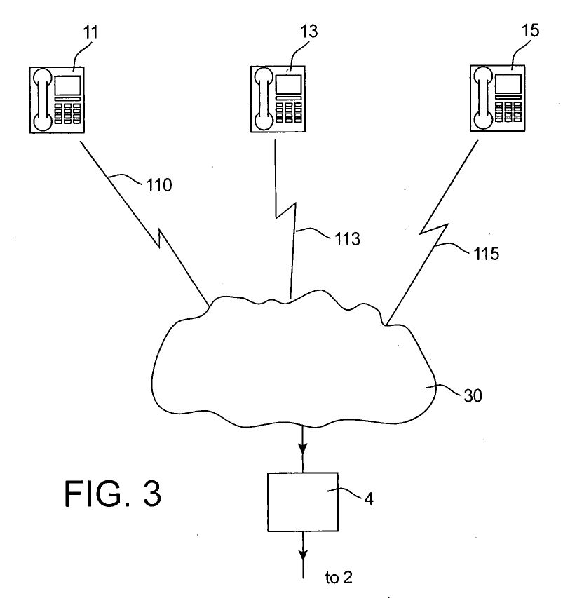

A set of means for applying the present invention will be described in connection with FIGS. 3 to 5.

In these figures, references identical with or similar to those of FIG. 1, refer to identical elements therein. The arrows 110, 113, 115 represent calls from each of the telephone sets 11, 13, 15 to the bridge 4 via the network 30.

Information relating to the presence of the user(s) is transmitted to the server 2, as explained above, the latter having a specific interface (see the management and supervision interface above) allowing it to converse with the bridge 4.

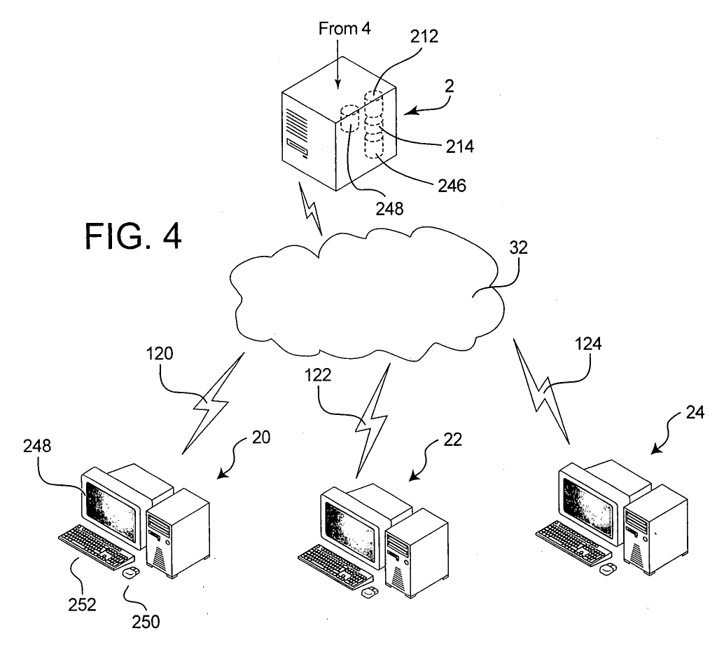

In FIG. 4, reference 2 refers to the computer or the conference management server, which the different users, each having, in addition to the telephone set 11, 12, 15 of FIG. 3, a PC type microcomputer 20, 22, 24, . . . , may connect to or have access to, via a network 32, for example the Internet.

Each of the users accesses the network through his/her own connection 120, 122, 124 . . . and has his/her own address.

The server stores in memorization means 42 data related to phone numbers of phone devices 11, 13, 15 and to terminals 20, 22, 24, as already explained above.

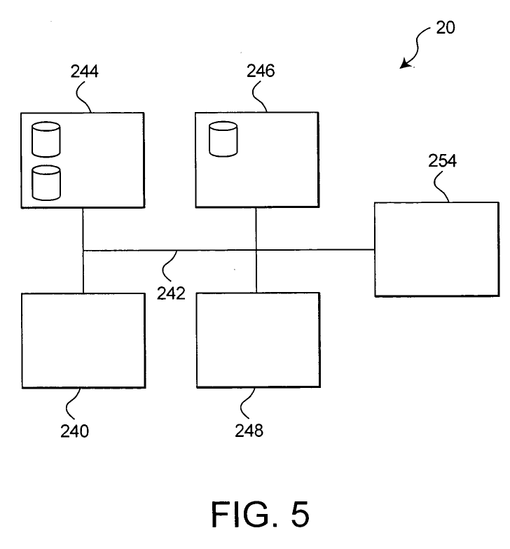

FIG. 5 schematically illustrates the different components of the microcomputer 20 as a whole. A microprocessor 240 is connected through a bus 242 to a set of RAM memories 244 for storing data, and to a ROM memory 246 in which program instructions may be stored. This system further includes a viewing device 248 or screen, and peripheral means 250 (keyboard) or 252 (mouse).

Reference 254 refers to means for interfacing with the network, of the modem type. The other apparatuses 22, 24 may have the same structure.

Generally, each user apparatus includes means for viewing remote conference data, notably of the multimedia type, and for example transmitted by the computer 2, via the network 30, and the communication and/or transmission means 120, 122, 124. It also includes means 50 for entering data, such as for example data relating to telephone numbers, these data being transmitted to the computer or to the server 10 by the same communication and/or transmission means.

The server overall has a structure of the same type, with processor(s), data storage areas (moreover designated in FIG. 4 by references 42, 44, 46, 48), a connection to the network 30, and an interface for connecting to the bridge 4.

In one of the memory areas of the server, program instructions or data are stored for applying a method according to the invention, and notably, depending on data received by the bridge 4, relating to the presence of participants in an audio conference, and depending on data relating to the telephone numbers and identification data for user apparatuses, for determining the apparatuses 20, 22, 24 to be included or participating in a conference.

Program instructions or data are also stored for sending data of this conference, for example multimedia data, or making them available to the participants in a conference according to either of the two modes discussed above.

Program instructions or data are also stored for applying a method as described above in connection with FIG. 2.

These data or instructions may be transferred into a memory area of the server from a diskette or any other medium which may be read by a microcomputer or a computer (for example: hard disk, read-only memory (ROM), dynamic random access memory (DRAM) or any other type of RAM memory, compact optical disk, magnetic or optical storage component).

1-14. (canceled)

15. A device for managing remote conferences, comprising:
means for receiving, from a telephone conference bridge, participant audio presence data in an audio conference;
storage means for storing user telephone number data and data identifying a user apparatus in connection with the telephone number data; and
means for determining, by the audio presence data and the stored data, apparatuses of participants in a conference.

16. The device according to claim 15, wherein the storage means stores a database of telephone and user apparatus identification number data.

17. The device according to claim 15, further comprising sending means for sending conference data to the apparatuses of participants in a conference.

18. The device according to claim 15, further comprising means for identifying a request for sending conference data to at least one of the apparatuses of a participant in a conference.

19. The device according to claim 15, further comprising means for determining a type of data, from the conference data, which may be provided to at least one of the apparatuses of a participant in a conference.

20. The device according to claim 15, further comprising sending means for sending to each user apparatus identified as a participant in a conference, data relating to the apparatuses of other users also participating in the conference.

21. A remote conference system, comprising:
a device according to claim 15; and
a plurality of apparatuses of users or participants.

22. A method for managing remote conferences, comprising:
receiving, via a device for managing conferences, audio presence data from a telephone conference bridge, concerning a presence of participants in a conference; and
determining apparatuses of users participating in or to be included in a conference, by the audio presence data and stored data identifying a user apparatus, in connection with telephone number data.

23. The method according to claim 22, wherein the audio presence data is communicated from the conference bridge to a management device as soon as a user alters his/her presence at an audio conference.

24. The method according to claim 22, wherein the conference data is addressed to an apparatus of a participant in the conference upon request from the participant.

25. The method according to claim 22, wherein the conference data is addressed to an apparatus of a participant in the conference without any specific request from the participant.

26. The method according to claim 22, wherein the data for identifying apparatuses of other users participating in the conference is addressed to at least one participant in the conference.

27. The method according to claim 22, wherein the stored data identifying a user apparatus in connection with telephone number data, is sent to a device for managing each apparatus during a request for establishing a conference or during a request for accessing an already existing conference.

28. The method according to claim 22, wherein the stored data identifying a user apparatus, in connection with telephone number data, is stored beforehand in a management device, before a request for establishing a conference or a request for accessing an already existing conference.

29. A computer program for implementing a method according to claim 22.

30. A computer readable medium storing data for implementing a method according to claim 22.
